(19) United States
(12) Patent Application Publication
(10) Pub. No.: US 2006/0235192 A1
(43) Pub. Date: Oct. 19, 2006

(54) Soluble, low dielectrical constant, unsymmetrical polyimide and a method for preparing the same

(76) Inventors: Suobo Zhang, Changchun City (CN); Wenmu Li, Changchun City (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/242,700

(22) Filed: Oct. 4, 2005

(30) Foreign Application Priority Data
Apr. 18, 2005 (CN) 2005100167157

(51) Int. Cl. C08G 69/08

(52) U.S. Cl. 528/310

(57) ABSTRACT

The present invention relates to a soluble unsymmetrical polyimide and a method for preparing the same. The soluble unsymmetrical polyimide can be obtained by polymerizing an easily prepared dihalogen-substituted phthalimide as the monomer in the presence of transition metal nickel catalyst. In the polymerization process, the linkage of C-C bond in polymer has modes of head-to head, tail to tail and head to tail. The solubility of the unsymmetrical polyimide originates from the unsymmetrical nature of the polymer. Only those improved unsymmetrical polyimide has excellent solubility, high mechanical properties, thermal stability, low dielectric constant and low linear expansion coefficient. The present invention directly synthesizes the unsymmetrical polyimide by means of coupling reaction. Thus, not only the steps of synthesizing dianhydride and diamine are omitted, but also the properties of the polymer are improved and the production cost is greatly reduced.

### CROSS-REFERENCE TO RELATED APPLICATIONS

This application claims priority to Chinese Patent Application No: 2005100167157, filed Apr. 18, 2005.

1. Field of the Invention

The present invention relates to an aprotic solvent-soluble, low dielectrical constant, unsymmetrical polyimide and a method for preparing the same.

2. Background of the Invention

Aromatic polyimides (PIs) are certainly one of the most successful classes of high-performance polymers and are widely used in many applications such as electrics, coatings, composite materials, and membranes, due to its good electric and mechanical properties, thermal stability. Polyimides are conventionally prepared by the condensation polymerization of aromatic dianhydride monomers with diamine monomers. For instance, U.S. Pat. No. 4,485,140 disclosed that polyimides were prepared by the polymerization of pyromellitic dianhydride with different diamines. U.S. Pat. No. 4,239,880 reported that polyimides were prepared by polymerization of diamine of 2,2′di(p-aminophenoxy)-diphenyl with different dianhydrides. The rigid polyimides (PI) prepared by the conventional method have a symmetrical structure characteristics that the dianhydride structure and diamine structure are arranged alternatively. In that case, there exists strong intramolecular interactions among chains such as charge transfer and polarization, which makes the polyimides difficult to be dissolved and difficult to be melted, and thus difficult to be processed. In addition, the costs of aromatic dianhydride and aromatic diamine are high, which limits their application in many fields. In this invention, we would like to present a novel method for the synthesis of organic soluble rigid-rod like polyimides by polymerization of synthetically simple and inexpensive asymmetric dichlorophthalimide monomers without decreasing the good properties of polyimides.

### SUMMARY OF THE INVENTION

One object of the present invention is to provide a soluble, low dielectrical constant, unsymmetrical polyimide polymer.

The other object of the present invention is to provide a method for preparing the soluble, low dielectrical constant, unsymmetrical polyimide.

According to one aspect of the present invention, a soluble, low dielectrical constant, unsymmetrical polyimide disclosed has the general formula

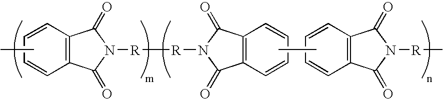

wherein n and m each is an integer being greater than 1, preferably from 2 to 1000, and R is a member selected from one, or two or more of the following group: 2-trifluoromethylphenyl, 2-methylphenyl, 2-trifluoromethoxyphenyl, 2-methoxyphenyl, 2-trifluoromethyl-4-phenoxyphenyl, 3-trifluoromethyl-4-phenoxyphenyl, 2-methyl-4-phenoxyphenyl, 3-methyl-4-phenoxyphenyl, 5-trifluoromethyl-2-phenoxyphenyl, 2-trifluoromethyl-5-phenoxyphenyl, 2-methyl-3-phenoxyphenyl or 2-methyl-5-phenoxyphenyl.

According to another aspect of the present invention, a method for preparing the above soluble, low dielectrical constant, unsymmetrical polyimide comprises:

using a dihalogen-substituted phthalimide of formula (I)

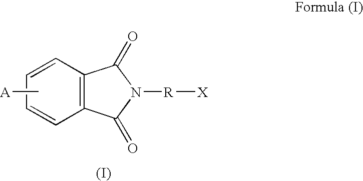

wherein A is selected from Cl or Br, the substitution site can be 3 or 4; R is a divalent aromatic radical which is the organic residue of a chloro-amine and selected from one, or two or more of the following group: 2-trifluoromethylphenyl, 2-methylphenyl, 2-trifluoromethoxyphenyl, 2-methoxyphenyl, 2-trifluoromethyl-4-phenoxyphenyl, 3-trifluoromethyl-4-phenoxyphenyl, 2-methyl-4-phenoxyphenyl, 3-methyl-4-phenoxyphenyl, 5-trifluoromethyl-2-phenoxyphenyl, 2-trifluoromethyl-5-phenoxyphenyl, 2-methyl-3-phenoxyphenyl or 2-methyl-5-phenoxyphenyl; and X is selected from Cl or Br and the substitution site can be 3 or 4;

to synthesize the soluble, low dielectrical constant, unsymmetrical polyimide by a coupling reaction at a temperature of 60 to 125° C. for 2 to 8 hr, under an inert gas atmosphere, in the presence of a nickel catalyst, a reducing agent and an aprotic solvent.

In a preferable aspect of the invention, the mole ratio of the nickel catalyst, the reducing agent and the dihalogen-substituted phthalimide of Formula (I) is 1:7 to 20:2 to 15, and preferably 1; 10 to 18:6 to 10.

In another preferable aspect of the invention, the nickel catalyst is selected from either one or a mixture of two or more of:
di-triphenyl phosphino-nickel dibromide,
di-triphenyl phosphino-nickel dichloride,
nickel bromide and triphenyl phosphine, and
nickel chloride and triphenyl phosphine or 2,2′-dipyridine.

In a preferable aspect of the invention, the method further comprises the steps of: after the coupling reaction, pouring the reaction product into the mixed solvent of HCl and ethanol in which the HCl concentration is 25% by weight, stirring, filtering, collecting the precipitate, and washing with ethanol and drying.

In another preferable aspect of the invention, the aprotic solvent is selected from one, or two or more of N,N-dimethylforamide, N,N-dimethylacetamide, N-methyl-2-pyrrolidone, dimethyl sulfoxide, epihydrin carbonate, sulfolane or tetrahydrofuran.

In a preferable aspect of the invention, the inherent viscosity of the soluble unsymmetrical polyimide was 0.32 to 1.45 dL/g measured at .30° Cin a mixed cresol as a solvent.

In another preferable aspect of the invention, the reducing agent is zinc powder.

In another preferable aspect of the invention, the inert gas atmosphere is a nitrogen atmosphere.

The method of the present invention not only omits the process of synthesizing diphenyl dianhydride but also improves the properties of the polymer and lowers the production cost.

### DETAILED DESCRIPTION OF THE PREFERRED EMBODIMENT

The soluble unsymmetrical polyimide of the present invention has the following structure:

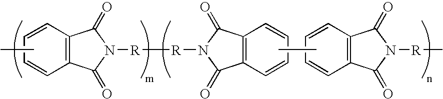

wherein n and m each is an integer being greater than 1, preferably from 2 to 1000, and R is a divalent aromatic radical which is the organic residue of a chloro-amine and R can be a member selected from one, or two or more of the following group: 2-trifluoromethylphenyl, 2-methylphenyl, 2-trifluoromethoxyphenyl, 2-methoxyphenyl, 2-trifluoromethyl-4-phenoxyphenyl, 3-trifluoromethyl-4-phenoxyphenyl, 2-methyl-4-phenoxyphenyl, 3-methyl-4-phenoxyphenyl, 5-trifluoromethyl-2-phenoxyphenyl, 2-trifluoromethyl-5-phenoxyphenyl, 2-methyl-3-phenoxyphenyl or 2-methyl-5-phenoxyphenyl.

The following components are used to synthesize the unsymmetrical polyimide of the present invention.
(1) Dihalogen substituted phthalimide monomer:

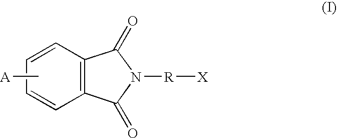

wherein A is selected from Cl or Br, the substitution site can be 3 or 4; R is a divalent aromatic radical which is the organic residue of a chloro-amine and selected from one, or two or more of the following group: 2-trifluoromethylphenyl, 2-methylphenyl, 2-trifluoromethoxyphenyl, 2-methoxyphenyl, 2-trifluoromethyl-4-phenoxyphenyl, 3-trifluoromethyl-4-phenoxyphenyl, 2-methyl-4-phenoxyphenyl, 3-methyl-4-phenoxyphenyl, 5-trifluoromethyl-2-phenoxyphenyl, 2-trifluoromethyl-5-phenoxyphenyl, 2-methyl-3-phenoxyphenyl or 2-methyl-5-phenoxyphenyl; and X is selected from Cl or Br and the substitution site can be 3 or 4;
(2) Reducing agent: zinc powder;
(3) Catalyst, selected from either one or a mixture of two or more of di-triphenyl phosphino-nickel dibromide,
di-triphenyl phosphino-nickel dichloride,
nickel bromide and triphenyl phosphine, and
nickel chloride and triphenyl phosphine or 2,2′-dipyridine.
(4) Aprotic solvent, selected from one, or two or more of N,N-dimethylforamide, N,N-dimethylacetamide, N-methyl-2-pyrrolidone, dimethyl sulfoxide, epihydrin carbonate, sulfolane or tetrahydrofuran.

The dihalogen-substituted phthalimides of formula (I) were synthesized by reacting an easily available halogen-substituted phthalic anhydride with a halogen-substituted aniline in the mole ratio of 1:1. 0.1 mol of the halogen-substituted phthalic anhydride, 0.1 mol of the halogen-substituted aniline and 100 to 500 ml of glacial acetic acid were stirred at room temperature for 30 min and then refluxed for 24 to 48 hrs. 20 to 400 ml of the glacial acetic was evaporated and the mixture was cooled, filtered and the precipitate was repeatedly washed with glacial acetic acid and then sublimed to yield the dihalogen-substituted phthalimide as a white crystal.

The soluble, unsymmetrical polyimide of the present invention was synthesized directly through a coupling reaction, in the presence of a transition metal catalyst, using a method similar to the method for synthesizing a biphenyl compound and a non-rigid polymer as described by Colon (I. Colon and D. Kelsey, J. Organic Chem., 1986, 51, 2627; I. Colon and C, N. Merriam, U. S. Pat. No. 4,486,576, Dec. 4, 1984). That is, 3 to 30 mmol of nickel salt, 12 to 150 mmol of triphenyl phosphine and optional 3 to 30 mmol of 2,2′-dipyridine and 70 to 400 mmol of zinc powder were put into a reaction flask altogether. After the oxygen in the flask was removed by nitrogen gas stream, 25 to 90 ml of aprotic solvent was added. The reaction mixture was stirred at 60 to 125° C, after the solution became red-brown, 120 to 650 ml of aprotic solvent and the unsymmetrical dihalogen-substituted phthalimide monomer were added. The reaction was continued for 2 to 8 hrs. Then the reaction product was poured into 1000 to 2500 ml of 25% HCl/ethanol solution and the mixture was stirred for 20 to 40 min, filtered. The precipitate collected was washed by refluxing with 250 to 800 ml ethanol for 4 to 8 hrs, and then filtered, and dried at 100 to 120° C. to yield the final product. The yield was 96% to 100%. The inherent viscosity of the final product in mixed cresol measured at 30° C. was 0.32 to 1.45 dL/g. The nickel salt used is nickel chloride or nickel bromide.

The polyimide thus prepared has the following structure:

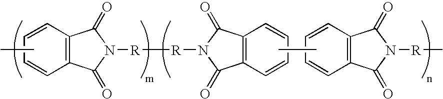

The formation of such irregular structure of polyimide results from that in the polymerization process, the linkage of C═C bond of the polymerizing monomer of the dihalogen-substituted phthalimide of formula (I) has a carbon atom on the head-head-A substituent with a carbon atom on -A substituent, a carbon atom on the tail-tail-X substituent with a carbon atom on -X substituent, or a carbon atom on the head-tail-A substituent with a carbon atom on -X substituent. The modes of linkage are as follows:

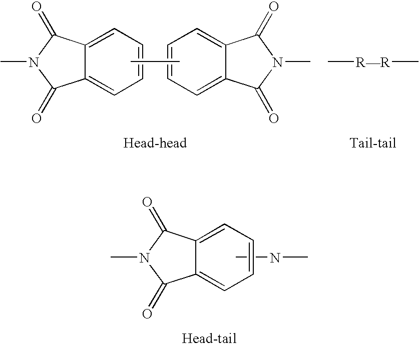

Such reaction may produce a polyimide from a conventional aromatic tetracarboxylic dianhydride and an aromatic diamine. The polyimide has a symmetrical structure characteristic of the dianhydride structure and the diamine structure alternatively arranged and has the unsymmetrical characteristics of head-tail structure.

The monomer used in the present invention is a dihalogen-substituted phthalimide, which is easily prepared from halogen-substituted phthalic anhydride and halogen-substituted aniline, without an aromatic tetracarboxylic dianhydride and an aromatic diamine.

The polyimide prepared by the present invention is soluble in a polar aprotic solvent such as N,N-dimethylforamide, N,N-dimethylacetamide, N-methyl-2-pyrrolidone, dimethyl sulfoxide, epihydrin carbonate, sulfolane, tetrahydrofuran etc. The improvement of the polyimide in solubility comes from the unsymmetrical structure. The polyimide of the present invention possesses outstanding comprehensive properties such as thermal stability, excellent solubility, outstanding electronic and mechanical properties. Films prepared by these polyimides have low water absorption, low dielectric constant and low linear expansion coefficient. Therefore, they are especially suitable to be used in microelectronics. They are also suitable to be used in fields of gas separation membrane and molecular separation membrane.

In the present invention, an unsymmetrical polyimide with irregular main chain structure is directly synthesized for the first time by a coupling reaction of an unsymmetrical dihalogen-substituted phthalimide in an aprotic solvent in the presence of transition metal nickel as the catalyst. In comparison with the conventional method, not only the properties of the polymer are improved but also the production cost is greatly lowered.

### EXAMPLE 1

In a 100 mL round-bottomed flask, a mixture of 1.825 g (0.10 mol) of 4-chlorophthalic anhydride, 1.576 g (0.010 mol) of 2-methoxy-4-chloroaniline, and 25 mL of acetic acid was stirred at ca. 40 ° C. for 30 min. The suspension was refluxed for 24 h, then, 10 mL of acetic acid was distilled off. The hot mixture was filtered, washed with acetic acid, and sublimed under vacuum at 180° C. 2.96 g of N-(4-chloro-2-methoxyphenyl)-4-chlorophthalimide was obtained as a white solid with a melting point of 198 to 200° C. The yield was 92%.

8 mmol of nickel chloride, 50 mmol of triphenylphosphine and 90 mmol of zinc powder were placed in a reaction flask in which the oxygen was removed by nitrogen gas stream. 25 ml of DMAc was added and stirred at 70° C. After the system became red-brown, 150 ml of DMAc and 50 mmol of N-(4-chloro-2-methoxyphenyl)-4-chlorophthalimide were added and reacted for 8 hr and then the reaction product was poured into 1500 ml of 25% HCl/ethanol solution and stirred for 30 min. The precipitate was filtered and washed with 400 ml of ethanol by refluxing for 4 hr. After that, the solid was collected by filtration, and dried at 110° C. 12.10 g of N-(4-chloro-2-methoxyphenyl)-4-chlorophthalimide polymer was obtained as the product. The yield was 96.4%. The inherent viscosity of the polymer in mixed cresol measured at 30° C. was 0.87 dL/g. The glass transition temperature T_{g} was 301° C. 5% Heat loss in weight Td_{5%} was 464. Elemental analysis data: calc. C: 71.71%, H: 3.59%, N: 5.58%; found C: 70.46%, H: 3.63%, N: 5.59%.

### EXAMPLE 2:

2.88 g of N-(4-chloro-2-methylphenyl)-4-chlorophthalimide as a white solid with a melting point of 193 to 195° Cwas obtained by using the same procedure as described in Example 1, excepted that 2-methoxy-4-chloroaniline were replaced by 1.416 g (0.010 mol) 2-methyl-4-chloroaniline. The yield was 96%.

20 mmol of nickel bromide, 100 mmol of triphenylphosphine and 300 mmol of zinc powder were placed in a reaction flask in which the oxygen was removed by nitrogen gas stream. 50 ml of DMF was added and stirred at 120° C. After the system became red-brown, 500 ml of DMF and 70 mmol of N-(4-chloro-2-methylphenyl)-4-chlorophthalimide were added and reacted for 5 hr and then the reaction product was poured into 2000 ml of 25% HCl/ethanol solution and stirred for 40 min. The precipitate was filtered and washed with 500 ml of ethanol by refluxing for 6 hr. After that, the solid was collected by filtration, and dried at 105° C. 11.26 g of N-(4-chloro-2-methylphenyl)-4-chlorophthalimide polymer was obtained as the product. The yield was 98.9%. The inherent viscosity of the polymer in mixed cresol measured at 30° C. was 1.02 dL/g. The glass transition temperature T_{g} was 339° C. 5% Heat loss in weight Td_{5%} was 467. Elemental analysis data: calc. C: 76.60%, H: 3.83%, N: 5.96%; found C: 75.39%, H: 3.92%, N: 5.54%.

### EXAMPLE 3

3.26 g of N-(4-chloro-2-methylphenyl)-4-bromophthalimide as a white solid with a melting point of 207 to 210° C. was obtained by using the same procedure as described in Example 1, excepted that 2-methoxy-4-chloroaniline and 4-bromohthalic anhydride were replaced by 1.416 g (0.010 mol) of 2-methyl-4-chloroaniline and 2.270 g (0.010) of 4-bromobenoic anhydride. The yield was 93%.

12 mmol of nickel bromide, 90 mmol of triphenylphosphine and 150 mmol of zinc powder were placed in a reaction flask in which the oxygen was removed by nitrogen gas stream. 40 ml of NMP was added and stirred at 105° C. After the system became red-brown, 400 ml of NMP and 60 mmol of N-(4-chloro-2-methylphenyl)-4-bromophthalimide were added and reacted for 2 hr and then the reaction product was poured into 1500 ml of 25% HCl/ethanol solution and stirred for 30 min. The precipitate was filtered and washed with 400 ml of ethanol by refluxing for 8hr. After that, the solid was collected by filtration, and dried at 100° C. 13.85 g of N-(4-chloro-2-methylphenyl)-4-bromophthalimide polymer was obtained as the product. The yield was 98.2%. The inherent viscosity of the polymer in mixed cresol measured at 30° Cwas 1.00 dL/g.

The glass transition temperature TG was 336° C. 5% Heat loss in weight Td_{5%} was 468. Elemental analysis data: calc. C: 76.60%, H: 3.83%, N: 5.96%; found C: 75.66%, H: 4.04%, N: 5.61%.

### EXAMPLE 4

3.30 g of N-(4-bromo-2-methylphenyl)-4-chlorophthalimide as a white solid with a melting point of 210 to 212° C. was obtained by using the same procedure as described in Example 1, except that 2-methoxy-4-chloroaniline were replaced by 1.861 g (0.010 mol) of 2-methyl-4-bromoaniline. The yield was 93%.

3 mmol of nickel bromide, 15 mmol of triphenylphosphine and 100 mmol of zinc powder were put into a reaction flask in which the oxygen was removed by nitrogen gas stream. 25 ml of DMAc was added and stirred at 115° C. After the system became red-brown, 160 ml of DMAc and 40 mmol of N-(4-bromo -2-methylphenyl)-4-chlorophthalimide were added and reacted for 6 hr and then the reaction product was poured into 900 ml of 25% HCl/ethanol solution and stirred for 30 min. The precipitate was filtered and washed with 250 ml of ethanol by refluxing for 5hr. After that, the solid was collected by filtration, and dried at 120° C. 9.12 g of N-(4-bromo -2-methylphenyl)-4-chlorophthalimide polymer was obtained as the product. The yield was 97.0%. The inherent viscosity of the polymer in mixed cresol measured at 30° C. was 0.95 dL/g.

The glass transition temperature T_{g} was 334° C. 5% Heat loss in weight Td_{5%} was 464. Elemental analysis data: calc. C: 76.60%, H: 3.83%, N: 5.96%; found C: 74.97%, H: 4.07%, N: 5.78%.

### EXAMPLE 5

3.80 g of N-[2-methyl -4-(4′-chlorophenoxy)phenyl]-4-chlorophthalimide as a white solid with a melting point of 229 to 231° C. was obtained by using the same procedure as described in Example 1, except that 2-methoxy-4-chloroaniline were replaced by 2,336 g (0.010 mol) of 2-methyl-4-(4′-chlorophenoxy)aniline. The yield was 95%.

5 mmol of di-triphenylphosphino-nickel dibromide, 10 mmol of 2,2′-dipyridine and 100 mmol of zinc powder were placed in a reaction flask in which the oxygen was removed by nitrogen gas stream. 30 ml of sulfolane was added and stirred at 100° C. After the system became red-brown, 150 ml of sulfolane and 50 mmol of N-[2-methyl -4-(4′-chlorophenoxy)phenyl]-4-chlorophthalimide were added and reacted for 8 hr and then the reaction product was poured into 1500 ml of 25% HCl/ethanol solution and stirred for 30 min. The precipitate was filtered and washed with 400 ml of ethanol by refluxing for 7hr. After that, the precipitate was filtered, and dried at 100° C. 15.75 g of N-[2-methyl -4-(4′-chlorophenoxy)phenyl]-4-chlorophthalimide polymer was obtained as the product. The yield was 96.3%. The inherent viscosity in mixed cresol measured at 30° C. of the polymer was 0.77 dL/g. The glass transition temperature T_{g} was 287 ° C. 5% Heat loss in weight Td_{5%} was 458. Elemental analysis data: calc. C: 76.60%, H: 3.95%, N: 4.26%; found C: 75.42%, H: 4.03%, N: 4.16%.

### EXAMPLE 6

3.88 g of N-[3-methyl -4-(4′-chlorophenoxy)phenyl]-4-chlorophthalimide as a white solid with a melting point of 232 to 234° Cwas obtained by using the same procedure as described in Example 1, except that 2-methoxy-4-chloroaniline were replaced by 2.336 g (0.010 mol) of 3-methyl-4-(4′-chlorophenoxy)aniline. The yield was 97%.

5 mmol of nickel bromide, 12 mmol of triphenylphosphine and 160 mmol of zinc powder were placed in a reaction flask in which the oxygen was removed by nitrogen gas stream. 40 ml of DMAc was added thereto and stirred at 95° C. After the system became red-brown, 150 ml of DMAc and 50 mmol of N-[3-methyl-4-(4′-chlorophenoxy)phenyl]-4-chlorophthalimide were added and reacted for 4 hr and then the reaction product was poured into 1000 ml of 25% HCl/ethanol solution and stirred for 30 min. The precipitate was filtered and washed with 400 ml of ethanol by refluxing for 6 hr. After that, the solid was collected by filtration, and dried at 1 10° C. 15.71 g of N-[3-methyl-4-(4′-chlorophenoxy)phenyl]-4-chlorophthalimide polymer was obtained as the product. The yield was 96.1%. The inherent viscosity of the polymer in mixed cresol measured at 30° C. was 0.80 dL/g. The glass transition temperature T_{g} was 279° C. 5% Heat loss in weight Td_{5%} was 449. Elemental analysis data: calc. C: 76.60%, H: 3.95%, N: 4.26%; found C: 76.01%, H: 3.99%, N: 4.28%.

### EXAMPLE 7

3.76 g of N-[2-methyl -3-(4′-chlorophenoxy)phenyl]-4-chlorophthalimide as a white solid with a melting point of 221 to 223° Cwas obtained by using the same procedure as described in Example 1, except that 2-methoxy-4-chloroaniline were replaced by 2.336 g (0.010 mol) 2-methyl-3-(4′-chlorophenoxy)aniline. The yield was 94%.

5 mmol of nickel chloride, 12 mmol of triphenylphosphine and 160 mmol of zinc powder were placed in a reaction flask in which the oxygen was removed by nitrogen gas stream. 40 ml of DMAc was added and stirred at 95° C. After the system became red-brown, 150 ml of DMAc and 25 mmol of N-[2-methyl-3-(4′-chlorophenoxy)phenyl]-4-chlorophthalimide were added and reacted for 4 hr and then the reaction product was poured into 800 ml of 25% HCl/ethanol solution and stirred for 30 min. The precipitate was filtered and washed with 400 ml of ethanol by refluxing for 6 hr. After that, the solid was collected by filtration, and dried at 110° C. 7.83 g of N-[2-methyl-3-(4′-chlorophenoxy)phenyl]-4-chlorophthalimide polymer was obtained as the product. The yield was 97.0%. The inherent viscosity of the polymer in mixed cresol measured at 30° C. was 0.35 dL/g. The glass transition temperature T_{g} was 286° C. 5% Heat loss in weight Td_{5%} was 453. Elemental analysis data: calc. C: 76.60%, H: 3.95%, N: 4.26%; found C: 75.88%, H: 4.10%, N: 4.05%.

### EXAMPLE 8

3.68 g of N-[2-methyl-5-(4′-chlorophenoxy)phenyl]-4-chlorophthalimide as a white solid with a melting point of 218 to 220° C. was obtained by using the same procedure as described in Example 1, except that 2-methoxy-4-chloroaniline in example 1 were replaced by 2.336 g (0.010 mol) 2-methyl-5-(4′-chlorophenoxy) aniline. The yield was 92%.

20 mmol of nickel bromide, 100 mmol of triphenylphosphine and 300 mmol of zinc powder were placed in a reaction flask in which the oxygen was removed by nitrogen gas stream. 60 ml of DMAc was added and stirred at 90° C. After the system became red-brown, 250 ml of DMAc and 100 mmol of N-[2-methyl-5-(4′-chlorophenoxy)phenyl]-4-chlorophthalimide were added thereto and reacted for 6 hr and then the reaction product was poured into 2500 ml of 25% HCl/ethanol solution and stirred for 30 min. The precipitate was filtered and washed with 800 ml ethanol by refluxing for 2 hr. After that, the solid was collected by filtration, and dried at 100° C. 31.72 g of N-[2-methyl-5-(4′-chlorophenoxy)phenyl]-4-chlorophthalimide polymer was obtained as the product. The yield was 97.0%. The inherent viscosity of the polymer in mixed cresol measured at 30° C was 0.53 dL/g. The glass transition temperature T_{g} was 283° C. 5% Heat loss in weight Td_{5%} was 455. Elemental analysis data: calc. C: 76.60%, H: 3.95%, N: 4.26%; found C: 75.23%, H: 4.18%, N: 4.17%.

### EXAMPLE 9

3.55 g of N-[4-chloro-2-trifluoromethylphenyl-4-chlorophthalimide as a white solid with a melting point of 157 to 158° C. was obtained by using the same procedure as described in Example 1, except that 2-methoxy-4-chloroaniline were replaced by 2.255 g (0.010 mol) of 2-trifluoromethyl-4-chloroaniline. The yield was 91%.

30 mmol of di-triphenylphosphino-nickel dichloride, 150 mmol of triphenylphosphine, 400 mmol of zinc powder, and 30 mmol 2,2′-dipyridine were placed in a reaction flask in which the oxygen was removed by nitrogen gas stream. 80 ml of NMP was added and stirred at 115° C. After the system became red-brown, 650 ml of NMP and 90 mmol of N-(4-chloro -2-trifluoromethylphenyl)-4-chlorophthalimide were added and reacted for 5 hr and then the reaction product was poured into 3500 ml of 25% HCl/ethanol solution and stirred for 30 min. The precipitate was filtered and washed with 800 ml of ethanol by refluxing for 8 hr. After that, the solid was collected by filtration, and dried at 100° C. 26.8 g of N-(4-chloro-2-trifluoromethylphenyl)-4-chlorophthalimide polymer was obtained as the product. The yield was 100%. The inherent viscosity of the polymer in mixed cresol measured at 30° C. was 1.45 dL/g. The glass transition temperature T_{g} was 353° C. 5% Heat loss in weight Td_{5%} was 535. Elemental analysis data: calc. C: 62.28%, H: 2.08%, N: 4.84%; found C: 61.82%, H: 2.17%, N: 4.68%.

### EXAMPLE 10

3.71 g of N-(4-chloro-2-trifluoromethylphenyl-3-chlorophthalimide as a white solid with a melting point of 168 to 170° C. was obtained by using the same procedure as described in Example 1, excepted that 2-methoxy-4-chloroaniline were replaced by 2.255 g (0.010 mol) 2-trifluoromethyl-4-chloroaniline. The yield was 95%.

10 mmol of nickel bromide, 15 mmol of triphenylphosphine and 100 mmol of zinc powder were placed in a reaction flask in which the oxygen was removed by nitrogen gas stream. 50 ml of THF was added and stirred at 60° C. After the system became red-brown, 250 ml of THF and 50 mmol of N-(4-chloro-2-trifluoromethylphenyl)-3-chlorophthalimide were added and reacted for 6 hr and then the reaction product was poured into 1500 ml of 25% HCl/ethanol solution and stirred for 30 min. The precipitate was filtered and washed with 400 ml of ethanol by refluxing for 7 hr. After that, the solid was collected by filtration, and dried at 100° C. 14.6 g of N-(4-chloro-2-trifluoromethylphenyl)-3-chlorophthalimide polymer was obtained as the product. The yield was 98.0%. The inherent viscosity of the polymer in mixed cresol measured at 30° C. was 0.32 dL/g. The glass transition temperature T_{g} was 354° C. 5% Heat loss in weight Td_{5%} was 542. Elemental analysis data: calc. C: 62.28%, H: 2.08%, N: 4.84%; found C: 61.32%, H: 2.16%, N: 4.77%.

### EXAMPLE 11

3.95 g of N-(4-chloro-2-trifluoromethylphenyl)-4-bromophthalimide as a white solid with a melting point of 174 to 175° C. was obtained by using the same procedure as described in Example 1, except that 2-methoxy-4-chloroaniline and 4-chlorophthalic anhydride were replaced by 2.255 g (0.010 mol) of 2-trifluoromethyl-4-chloroaniline and 2.270 g (0.010 mol) 4-bromobenzoic anhydride. The yield was 91%.

15 mmol of nickel bromide, 80 mmol of triphenylphosphine and 150 mmol of zinc powder were placed in a reaction flask in which the oxygen was removed by nitrogen gas stream. 60 ml of DMSO was added and stirred at 105° C. After the system became red-brown, 350 ml of DMSO and 50 mmol of N-(4-chloro-2-trifluoromethylphenyl)-4-bromophthalimide were added and reacted for 4 hr and then the reaction product was poured into 1500 ml of 25% HCl/ethanol solution and stirred for 30 min. The precipitate was filtered and washed with 400 ml of ethanol by refluxing for 8 hr. After that, the solid was collected by filtration, and dried at 100° C. 14.5 g of N-(4-chloro-2-trifluoromethylphenyl)-4-bromophthalimide polymer was obtained as the product. The yield was 97.3%. The inherent ,viscosity of the polymer in mixed cresol measured at 3⁰° Cwas 1.35 dL/g. The glass transition temperature T_{g} was 356° C. 5% Heat loss in weight Td_{5%} was 521. Elemental analysis data: calc. C: 62.28%, H: 2.08%, N: 4.84%; found C: 61.54%, H: 2.20%, N: 4.73%.

### EXAMPLE 12

4.27 g of N-[2-trifluoromethyl-4-(4′-chlorophenoxy)phenyl]-4-chlorophthalimide as a white solid with a melting point of 192 to 195° C. was obtained by using the same procedure as described in Example=1, excepted that 2-methoxy-4-chloroaniline were replaced by 2.877 g (0.10 mol) of 2-trifluoromethyl-4-(4′-chlorophenoxy)aniline. The yield was 94.5%.

15 mmol of nickel bromide, 80 mmol of triphenylphosphine and 150 mmol of zinc powder were placed in a reaction flask in which the oxygen was removed by nitrogen gas stream. 50 ml of DMAc was added and stirred at 70° C. After the system became red-brown, 150 ml of DMAc and 50 mmol of N-[2-trifluoromethyl-4-(4′-chlorophenoxy)phenyl]-4-chlorophthalimide were added and reacted for 8 hr and then the reaction product was poured into 1500 ml of 25% HCl/ethanol solution and stirred for 30 min. The precipitate was filtered and washed with 400 ml of ethanol by refluxing for 6 hr. After that, the solid was collected by filtration, and dried at 100° C. 19.38 g of N-[2-trifluoromethyl-4-(4′-chlorophenoxy)phenyl]-4-chlorophthalimide polymer was obtained as the product. The yield was 98.6%. The inherent viscosity of the polymer in mixed cresol measured at 30° C. was 0.83 dL/g. The glass transition temperature T_{g} was 296° C. 5% Heat loss in weight Td_{5%} was 521. Elemental analysis data: calc. C: 65.80%, H: 2.61%, N: 3.66%; found C: 63.71%, H: 2.75%, N: 3.49%.

### EXAMPLE 13

4.16 g of N-[3-trifluoromethyl-4-(4′-chlorophenoxy)phenyl]-4-chlorophthalimide as a white solid with a melting point of 196 to 197° C. was obtained by using the same procedures described in Example 1, except that 2-methoxy-4-chloroaniline were replaced by 2.877 g (0.010 mol) of 3-trifluoromethyl-4-(4′-chlorophenoxy)aniline. The yield was 92%.

15 mmol of nickel bromide, 90 mmol of triphenylphosphine and 140 mmol of zinc powder were placed in a reaction flask in which the oxygen was removed by nitrogen gas stream. 60 ml of DMAc was added and stirred at 125° C. After the system became red-brown, 150 ml of DMAc and 50 mmol of N-[3-trifluoromethyl-4-(4′-chlorophenoxy)phenyl]-4-chlorophthalimide were added and reacted for 7 hr and then the reaction product was poured into 1500 ml of 25% HCl/ethanol solution and stirred for 30 min. The precipitate was filtered and washed with 600 ml of ethanol by refluxing for 8 hr. After that, the solid was collected by filtration, and dried at 100IC. 19.0 g of N-[3-trifluoromethyl-4-(4′-chlorophenoxy)phenyl]-4-chlorophthalimide polymer was obtained as the product. The yield was 97.4%. The inherent viscosity of the polymer in mixed cresol measured at 30° C. was 1.11 IdL/g. The glass transition temperature T_{g} was 294° C. 5% Heat loss in weight Td_{5%} was 524. Elemental analysis data: calc. C: 65.80%, H: 2.61%, N: 3.66%; found C: 64.51%, H: 3.26%, N: 3.30%.

### EXAMPLE 14

4.07 g of N-[5-trifluoromethyl-2-(4′-chlorophenoxy)phenyl]-4-chlorophthalimide as a white solid with a melting point of 187 to 189° C. was obtained by using the same procedure as described in Example 1, except that 2-methoxy-4-chloroaniline were replaced by 2.877 g (0.010 mol) of 5-trifluoromethyl-2-(4′-chlorophenoxy)aniline. The yield was 90%.

10 mmol of nickel bromide, 50 mmol of triphenylphosphine and 150 mmol of zinc powder were placed in a reaction flask in which the oxygen was removed by nitrogen gas stream. 40 ml of DMF was added and stirred at 105° C. After the system became red-brown 150 ml of DMF and 50 mmol of N-[5-trifluoromethyl-2-(4′-chlorophenoxy)phenyl]-4-chlorophthalimide were added and reacted for 8 hr and then the reaction product was poured into 1500 ml of 25% HCl/ethanol solution and stirred for 60 min. The precipitate was filtered and washed with 600 ml of ethanol by refluxing for 8 hr. After that, the solid was collected by filtration, and dried at 100° C. 19.0 g of N-[5-trifluoromethyl-2-(4′-chlorophenoxy)phenyl]-4-chlorophthalimide polymer was obtained as the product. The yield was 97.4%. The inherent viscosity of the polymer in mixed cresol measured at 30° C. was 1.13 dL/g. The glass transition temperature T_{g} was 302° C. 5% Heat loss in weight Td_{5%} was 518. Elemental analysis data: calc. C: 65.80%, H: 2.61%, N: 3.66%; found C: 65.11%, H: 2.87%, N: 3.53%.

### EXAMPLE 15

4.12 g of N-[2-trifluoromethyl-4-(3′-chlorophenoxy)phenyl]-4-chlorophthalimide as a white solid with a melting point of 190 to 191° C. was obtained by using the same procedure as described in Example 1, except that 2-methoxy-4-chloroaniline were replaced by 2.877 g (0.010 mol) of 2-trifluoromethyl-4-(3′-chlorophenoxy)aniline. The yield was 91.2%.

10 mmol of nickel bromide, 45 mmol of triphenylphosphine and 70 mmol of zinc powder were placed in a reaction flask in which the oxygen was removed by nitrogen gas stream. 50 ml of sulfolane was added and stirred at 70° C. After the system became red-brown, 150 ml of sulfolane and 50 mmol of N-[2-trifluoromethyl-4-(3′-chlorophenoxy)phenyl]-4-chlorophthalimide were added and reacted for 6 hr and then the reaction product was poured into 1500 ml of 25% HCl/ethanol solution and stirred for 30 min. The precipitate was filtered and washed with 550 ml of ethanol by refluxing for 4 hr. After that, the solid was collected by filtration, and dried at 100° C. 18.50 g of N-[2-trifluoromethyl-4-(3′-chlorophenoxy)phenyl]-4-chlorophthalimide polymer was obtained as the product. The yield was 94.9%. The inherent viscosity of the polymer in mixed cresol measured at 30° C. was 0.82 dL/g. The glass transition temperature T_{g} was 304° C. 5% Heat loss in weight Td_{5%} was 513. Elemental analysis data: calc. C: 65.80%, H: 2.61%, N: 3.66%; found C: 64.55%, H: 2.76%, N: 3.37%.

### EXAMPLE 16

4.21 g of N-[2-trifluoromethyl-5-(4′-chlorophenoxy)phenyl]-4-chlorophthalimide as a white solid with a melting point of 193 to 194° C. was obtained by using the same procedure as described in Example 1, except that 2-methoxy-4-chloroaniline in example 1 were replaced by 2.877 g (0.010 mol) 2-trifluoromethyl-5-(4′-chlorophenoxy)aniline. The yield was 93%.

20 mmol of nickel bromide, 100 mmol of triphenylphosphine and 300 mmol of zinc powder were placed in a reaction flask in which the oxygen was removed by nitrogen gas stream. 90 ml of DMAc was added and stirred at 125° C. After the system became red-brown, 180 ml of DMAc and 50 mmol of N-[2-trifluoromethyl-5-(4′-chlorophenoxy)phenyl]-4-chlorophthalimide were added and reacted for 6 hr and then the reaction product was poured into 1500 ml of 25% HCl/ethanol solution and stirred for 30 min. The precipitate was filtered and washed with 800 ml of ethanol by refluxing for 8 hr. After that, the solid was collected by filtration, and dried at 100° C. 18.4 g of N-[2-trifluoromethyl-5-(4′-chlorophenoxy)phenyl]-4-chlorophthalimide polymer was obtained as the product. The yield was 96.7%. The inherent viscosity of the polymer in mixed cresol measured at 3⁰° Cwas 1.08 dL/g. The glass transition temperature T_{g} was 291° C. 5% Heat loss in weight Td_{5%} was 502. Elemental analysis data: calc. C: 65.80%, H: 2.61%, N: 3.66%; found C: 64.66%, H: 2.82%, N: 3.44%.

### EXAMPLE 17

4.07 g of N-(4-chloro-2-trifluoromethoxyphenyl)-4-chlorophthalimide as a white solid with a melting point of 156 to 157° C. was obtained by using the same procedure as described in Example 1, except that 2-methoxy-4-chloroaniline were replaced by 2.415 g (0.010 mol) of 2-trifluoromethoxy-4-chloroaniline. The yield was 96%.

5 mmol of nickel bromide, 20 mmol of triphenylphosphine, 3 mmol of 2,2′-dipyridine and 100 mmol of zinc powder were placed in a reaction flask in which the oxygen was removed by nitrogen gas stream. 30 ml of DMAc was added and stirred at 125° C. After the system became red-brown, 120 ml of DMAc and 30 mmol of N-(4-chloro-2-trifluoromethoxyphenyl)-4-chlorophthalimide were added and reacted for 4 hr and then the reaction product was poured into 800 ml of 25% HCl/ethanol solution and stirred for 30 min. The precipitate was filtered and washed with 450 ml of ethanol by refluxing for 8 hr. After that, the solid was collected by filtration, and dried at 100° C. 9.30 g of N-(4-chloro-2-trifluoromethoxyphenyl)-4-chlorophthalimide polymer was obtained as the product. The yield was 98.6%. The inherent viscosity of the polymer in mixed cresol measured at 30° C was 1.32 dL/g. The glass transition temperature T_{g} was 336° C. 5% Heat loss in weight Td_{5%} was 562. Elemental analysis data: calc. C: 59.02%, H: 1.97%, N: 4.59%; found C: 57.76%, H: 2.18%, N: 4.43%.

### EXAMPLE 18

2.88 g of N-(4-chloro-2,6-dimethylphenyl)-4-chlorophthalimide with a melting point of the 175 to 176° C. was obtained by using the same procedure as described in Example 1, except that 2-methoxy-4-chloroaniline and 4-chlorophthalic anhydride were replaced by 1.556 g (0.010 mol) 2,6-dimethyl-4-chloroaniline and 1.825 g (0.010 mol) of 4-chlorophthalic anhydride The yield was 90%.

10 mmol of nickel bromide, 45 mmol of triphenylphosphine and 70 mmol of zinc powder were placed in a reaction flask in which the oxygen was removed by nitrogen gas stream. 50 ml of NMP was added and stirred at 105° C. After the system became red-brown, 150 ml of NMP and 50 mmol of N-(4-chloro-2,6-dimethylphenyl)-4-chlorophthalimide were added and reacted for 7 hr and then the reaction product was poured into 1500 ml of 25% HCl/ethanol solution and stirred for 60 min. The precipitate was filtered and washed with 400 ml of ethanol by refluxing for 8 hr. After that, the solid was collected by filtration, and dried at 100° C. 12.1 g of N-(4-chloro-2,6-dimethylphenyl) -4-chlorophthalimide polymer was obtained as the product. The yield was 96.8%. The inherent viscosity of the polymer in mixed cresol measured at 30° C. was 0.76 dL/g.

The glass transition temperature T_{g} was 344° C. 5% Heat loss in weight Td_{5%} was 463. Elemental analysis data: calc. C: 76.80%, H: 4.80%, N: 5.60%; found C: 75.61%, H: 4.96%, N: 5.37%.

### EXAMPLE 19

10 mmol of nickel bromide, 40 mmol of triphenylphosphine, 20 mmol 2,2′-dipyridine and 200 mmol of zinc powder were placed in a reaction flask in which the oxygen was removed by nitrogen gas stream. 60 ml of DMAc was added and stirred at 125° C. After the system became red-brown, 300 ml of DMAc, 40 mmol of N-(4-chloro-2-trifluoromethylphenyl)-4-chlorophthalimide and 10 mmol of N-(4-chloro-2-trifluoromethylphenyl)-3-chlorophthalimide were added and reacted for 4 hr and then the reaction product was poured into 800 ml of 25% HCl/ethanol solution and stirred for 30 min. The precipitate was filtered and washed with 700 ml of ethanol by refluxing for 8 hr. After that, the solid was collected by filtration, and dried at 100° C. 14.89 g of N-(4-chloro-2-trifluoromethylphenyl)-4-chlorophthalimide and N-(4-chloro-2-trifluoromethylphenyl)-3-chlorophthalimide copolymer was obtained as the product. The yield was 98.6%. The inherent viscosity of the polymer in mixed cresol measured at 30° C. was 0.87 dL/g. The glass transition temperature T_{g} was 348° C. 5% Heat loss in weight Td_{5%} was 553. Elemental analysis data: calc. C: 62.28%, H: 2.08%, N: 4.84%; found C: 61.89%, H: 2.35%, N: 4.55%.

### EXAMPLE 20

10 mmol of nickel bromide, 50 mmol of triphenylphosphine, 20 mmol 2,2′-dipyridine and 200 mmol of zinc powder were placed in a reaction flask in which the oxygen was removed by nitrogen gas stream. 60 ml of epihydrin carbonate was added and stirred at 125° C. After the system became red-brown, 250 ml of epihydrin carbonate and 42.5 mmol of N-(4-chloro-2-trifluoromethylphenyl)-4-chlorophthalimide and 7.5 mmol.of N-(4-chloro-2-trifluoromethylphenyl)-3-chlorophthalimide were added and reacted for 4 hr and then the reaction product was poured into 700 ml of 25% HCl/ethanol solution and stirred for 30 min. The precipitate was filtered and washed with 700 ml of ethanol by refluxing for 8 hr. After that, the solid was collected by filtration, and dried at 100° C. 14.78 g of N-(4-chloro-2-trifluoromethylphenyl)-4-chlorophthalimide and N-(4-chloro-2-trifluoromethylphenyl)-3-chlorophthalimide copolymer was obtained as the product. The yield was 97.9%. The inherent viscosity of the polymer in mixed cresol measured at 30° C. was 0.93 dL/g. The glass transition temperature T_{g} was 346° C. 5% Heat loss in weight Td_{5%} was 559. Elemental analysis data: calc. C: 62.28%, H: 2.08%, N: 4.84%; found C: 61.73%, H: 2.22%, N: 4.74%.

What is claimed is:

1. A soluble, low dielectrical constant, unsymmetrical polyimide having the following structure: 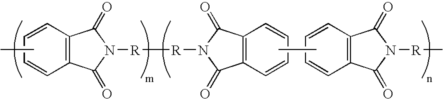
wherein n and m each is an integer from 2 to 1000, and R is an organic group selected from the group consisting of 2-trifluoromethylphenyl, 2-methylphenyl, 2-trifluoromethoxyphenyl, 2-methoxyphenyl, 2-trifluoromethyl-4-phenoxyphenyl, 3-trifluoromethyl-4-phenoxyphenyl, 2-methyl-4-phenoxyphenyl, 3-methyl-4-phenoxyphenyl, 5-trifluoromethyl-2-phenoxyphenyl, 2-trifluoromethyl-5-phenoxyphenyl, 2-methyl-3-phenoxyphenyl and 2-methyl-5-phenoxyphenyl, or a combination thereof.

2. A method for preparing the soluble, low dielectrical constant, unsymmetrical polyimide as claimed in claim 1, comprising using a dihalogen-substituted phthalimide of formula (I) 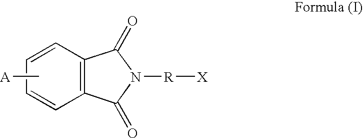
wherein A is selected from Cl or Br, the substitution site is 3 or 4; R is an organic group selected from selected from the group consisting of 2-trifluoromethylphenyl, 2-methylphenyl, 2-trifluoromethoxyphenyl, 2-methoxyphenyl, 2-trifluoromethyl-4-phenoxyphenyl, 3-trifluoromethyl-4-phenoxyphenyl, 2-methyl-4-phenoxyphenyl, 3-methyl-4-phenoxyphenyl, 5-trifluoromethyl-2-phenoxyphenyl, 2-trifluoromethyl-5-phenoxyphenyl, 2-methyl-3-phenoxyphenyl, and 2-methyl-5-phenoxyphenyl, or a combination thereof; and X is selected from Cl or Br and the substitution site is 3 or 4;
to synthesize the soluble unsymmetrical polyimide by a coupling reaction at a temperature of 60 to 125° C. for 2 to 8 hr, under an inert gas atmosphere, in the presence of a nickel catalyst, a reducing agent and an aprotic solvent.

3. The method of preparing the soluble, unsymmetrical polyimide as claimed in claim 2, wherein the mole ratio of the nickel catalyst, the reducing agent and the dihalogen-substituted phthalimide of Formula (I) is 1: 7 to 20:2 to 15.

4. The method of preparing the soluble, unsymmetrical polyimide as claimed in claim 3, wherein the mole ratio of the nickel catalyst, the reducing agent and the dihalogen-substituted phthalimide of Formula (I) is 1:10 to 18:6 to 10.

5. The method of preparing the soluble, unsymmetrical polyimide as claimed in claim 2, wherein the nickel catalyst is selected from either one or a mixture of two or more of
di-triphenyl phosphino-nickel dibromide,
di-triphenyl phosphino-nickel dichloride,
nickel bromide and triphenyl phosphine, and
nickel chloride and triphenyl phosphine or 2,2′-dipyridine.

6. The method of preparing the soluble, unsymmetrical polyimide as claimed in claim 2, further comprising the steps of: after the coupling reaction, pouring the reaction product into the mixed solvent of HCl and ethanol, stirring, filtering, collecting the precipitate, and washing with ethanol and drying.

7. The method of preparing the soluble, unsymmetrical polyimide as claimed in claim 2, wherein the aprotic solvent is selected from one, or two or more of N,N-dimethylforamide, N,N-dimethylacetamide, N-methyl-2-pyrrolidone, dimethyl sulfoxide, epihydrin carbonate, sulfolane or tetrahydrofuran.

8. The method of preparing the soluble, unsymmetrical polyimide as claimed in claim 2, wherein the inherent viscosity of the soluble unsymmetrical polyimide in a mixed cresol as a solvent measured at 30° C. was 0.32 to 1.45 dL/g.

9. The method of preparing the soluble, unsymmetrical polyimide as claimed in claim 2, wherein the reducing agent is zinc powder.

10. The method of preparing the soluble, unsymmetrical polyimide as claimed in claim 2, wherein the inert gas atmosphere is a nitrogen gas atmosphere.
